(19) United States
(12) Patent Application Publication
(10) Pub. No.: US 2024/0204425 A1
(43) Pub. Date: Jun. 20, 2024

(54) SMART ANTENNA MODULE AND PORTABLE ELECTRONIC DEVICE APPLYING THE SAME

(71) Applicant: Advanced Wireless & Antenna INC., New Taipei City (TW)

(72) Inventors: Lan-Hsin Wang, New Taipei City (TW); Jia-Ming Chang, New Taipei City (TW)

(21) Appl. No.: 18/540,499

(22) Filed: Dec. 14, 2023

(30) Foreign Application Priority Data
Dec. 14, 2022 (TW) 111213836

(51) Int. Cl. H01Q 25/00; H01Q 1/22; H01Q 23/00

(52) U.S. Cl. CPC H01Q 25/002; H01Q 1/2266; H01Q 23/00

(57) ABSTRACT

A smart antenna module is adapted to be assembled on a portable electronic device and includes first and second antenna bodies, first and second switch elements, and a driving control element. The second antenna body is electrically connected to the first antenna body and configured to receive or transmit a wireless signal together with the first antenna body. The first and second switch elements are electrically connected to the first and second antenna bodies, respectively. The driving control element is electrically connected to the first and second antenna bodies and the first and second switch elements. The driving control element is connected to the first antenna body to receive the wireless signal, and the driving control element is configured to transmit a control signal to control the first and second switch elements to be turned on or off so as to switch a radiation pattern of the smart antenna module.

### CROSS-REFERENCE TO RELATED APPLICATION

This non-provisional application claims priority under 35 U.S.C. § 119(a) to patent application Ser. No. 11/213,836 in Taiwan, R.O.C. filed on Dec. 14, 2022, the entire contents of which are hereby incorporated by reference.

### FIELD OF THE INVENTION

The instant disclosure relates to the field of antenna, and more particular to a smart antenna module and a portable electronic device applying the same.

### BACKGROUND

For portable electronic devices known to the inventor, these electronic devices correspond to a certain frequency band. Thus, each of these electronic device is equipped with a single antenna adopting a certain frequency band (for example, Wi-Fi wireless signals or 5G wireless signals). In general, when a single antenna is tested by a conductive T-put system, the intensity of the antenna at a specific angle (the so called “blind angle”) is founded to be weaker. This is a disadvantage that cannot be overcome easily by the single antenna.

### SUMMARY OF THE INVENTION

Moreover, in general, the antenna modules are directly supplied to the system integrators of electronic devices. However, with the changes of the designs or application environments of portable electronic devices, the antenna may be shielded or interfered with by other components. Furthermore, with the trend toward thinning and lightweight designs of the portable electronic device, the space for the antenna is also reduced. As a result, it is expected that issues of shielding or interference will become much severer because the stacking density of the components inside portable electronic device is increasing.

Antenna designers may offer customized services to adjust the structure of the antenna in portable electronic devices to meet their communication needs. However, the time from the manufacturing of antenna to the testing of antenna is longer for the customized service, and thus the antenna product may not be provided on time.

To address the problem encountered by the prior arts, according to one or some embodiments, a smart antenna module is provided. The smart antenna module is adapted to be assembled on a portable electronic device, and the smart antenna module comprises a first antenna body, a second antenna body, a first switch element, a second switch element, and a driving control element.

The second antenna body is electrically connected to the first antenna body, and the first antenna body and the second antenna body are configured to together receive or transmit a wireless signal. The first switch element is electrically connected to the first antenna body. The second switch element is electrically connected to the second antenna body. The driving control element is electrically connected to the first antenna body, the second antenna body, the first switch element, and the second switch element. The driving control element is connected to a feed-in point of the first antenna body so as to receive the wireless signal, and the driving control element is configured to transmit a control signal generated according to the wireless signal to control the first switch element and the second switch element to be turned on or turned off so as to switch a radiation pattern of the smart antenna module.

In some embodiments, the driving control element, the first switch element, and the second switch element are assembled on a flexible circuit board.

In some embodiments, the first switch element and the second switch element are diode elements or transistor elements.

In some embodiments, a frequency band of the wireless signal configured to be received by the first antenna body and the second antenna body is a Wi-Fi frequency band.

In some embodiments, a frequency band of the wireless signal configured to be received by the first antenna body and the second antenna body is a 5G frequency band.

In some embodiments, a frequency band of the wireless signal configured to be received by the first antenna body and the second antenna body is a 4G frequency band.

In some embodiments, the smart antenna module further comprises a third switch element and a fourth switch element. The first switch element is electrically connected to the first antenna body, and the fourth switch element is electrically connected to the second antenna body. The driving control element is electrically connected to the third switch element and the fourth switch element, and the driving control element further controls the third switch element and the fourth switch element to be turned on or turned off.

Moreover, in some embodiments, the driving control element, the first switch element, the second switch element, the third switch element, and the fourth switch element are assembled on a flexible circuit board.

Moreover, in some embodiments, the third switch element and the fourth switch element are diode elements or transistor elements.

Furthermore, a portable electronic device is further provided, and the portable electronic device is assembled with a smart antenna module according to aforementioned embodiment(s).

As above, according to one or some embodiments of the instant disclosure, when the smart antenna module is receiving the wireless signal, according to the blind angle of the current radiation pattern of the antenna, the on/off switching of the first switch element and the second switch element can be controlled through the driving of the driving control element to choose a suitable radiation pattern. Therefore, the blind angle for communication can be reduced, thereby allowing the communication performance of the portable electronic device at various fields to be further enhanced.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a smart antenna module according to a first embodiment of the instant disclosure;

FIG. 2A and FIG. 2B illustrate reference transmitting/receiving radiation patterns of the smart antenna module according to some embodiments of the instant disclosure tested by a conductive T-put system;

FIG. 3A and FIG. 3B illustrate transmitting/receiving radiation patterns of a first mode of the smart antenna module of some embodiments tested by the conductive T-put system;

FIG. 4A and FIG. 4B illustrate transmitting/receiving radiation patterns of a second mode of the smart antenna module of some embodiments tested by the conductive T-put system;

FIG. 5A and FIG. 5B illustrate transmitting/receiving radiation patterns of a third mode of the smart antenna module of some embodiments tested by the conductive T-put system;

FIG. 6A and FIG. 6B illustrate transmitting/receiving radiation patterns of a fourth mode of the smart antenna module of some embodiments tested by the conductive T-put system;

FIG. 7 illustrates a perspective view of a smart antenna module according to a second embodiment of the instant disclosure;

FIG. 8 illustrates a perspective view of a smart antenna module according to a third embodiment of the instant disclosure;

FIG. 9 illustrates a side view of a portable electronic device assembled with a smart antenna module according to some embodiments of the instant disclosure; and

FIG. 10 illustrates an enlarged schematic view of the region A shown in FIG. 9.

### DETAILED DESCRIPTION

In the following descriptions, it will be understood that, although the terms “first”, “second”, “third”, etc. may be used herein to describe various elements, components, regions, and/or sections, these terms are only used to distinguish these elements, components, regions, and/or sections, rather than are used to represent the definite order of these elements, components, regions, and/or sections. Moreover, spatially relative terms, such as “beneath,” “below,” “lower,” “above,” “upper,” “in,” “out,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. In other words, these terms only represent a relative position relationship between the described components, not an absolute position relationship between the described components.

In the drawings, for the sake of clarity, the sizes of some elements and regions are magnified. In the whole description, the identical reference number indicates the identical element. It should be understood that, when an element is referred to as being “on”, “connected to”, or “disposed on” another element, it may be directly on, connected to, or disposed on the other element, or one or more intervening elements may also be present. On the contrary, when one element is referred to as being “directly (disposed) on” or “directly connected to” another element, it can be clearly understood that there are no intervening elements between the two elements.

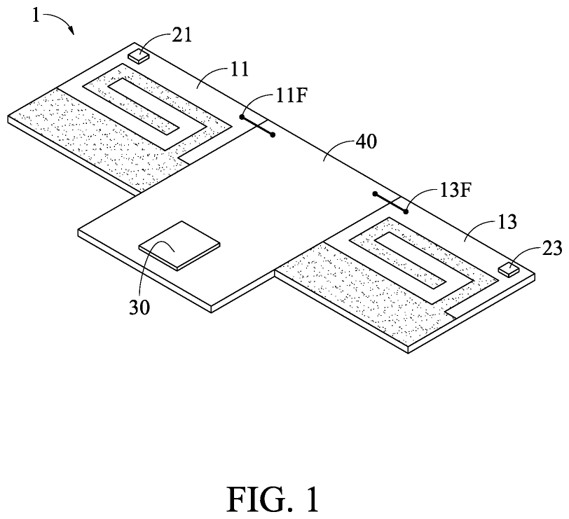

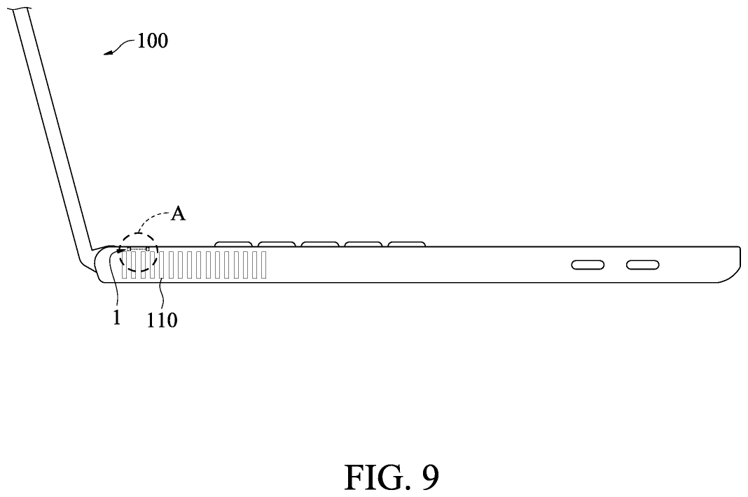

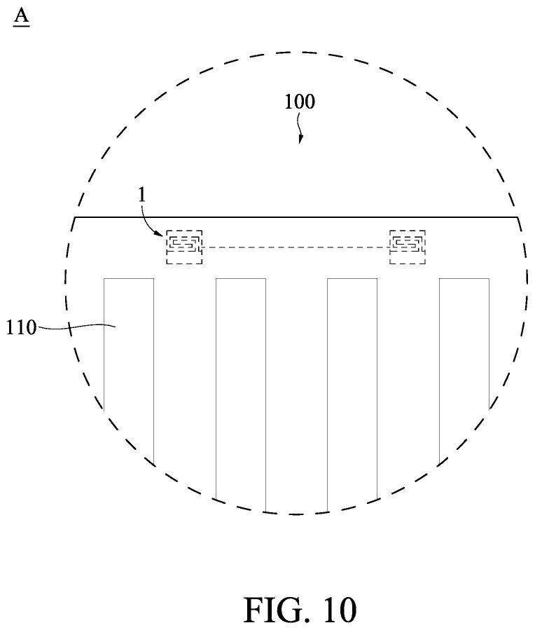

FIG. 1 illustrates a perspective view of a smart antenna module according to a first embodiment of the instant disclosure. As shown in FIG. 1, the smart antenna module 1 is adapted to be assembled on a portable electronic device 100 (as shown in FIG. 9 and FIG. 10). The portable electronic device 100 may be a notebook computer, a tablet computer, a mobile phone, or the like. The smart antenna module 1 comprises a first antenna body 11, a second antenna body 13, a first switch element 21, a second switch element 23, and a driving control element 30.

The second antenna body 13 is electrically connected to the first antenna body 11, and the first antenna body 11 and the second antenna body 13 are configured to jointly receive or transmit a wireless signal. In this embodiment, one of the first antenna body 11 and the second antenna body 13 may serve as a main radiation body, and the other serves as an auxiliary radiation body to deploy a suitable radiation pattern. The two antenna bodies may be connected with each other through a circuit board 40; however, the instant disclosure is not limited thereto. In some practical scenarios, the two antenna bodies may be connected with each other through a signal line, allowing the signal and electrical connection between the two antenna bodies to be achieved.

The first switch element 21 is electrically connected to the first antenna body 11. The second switch element 23 is electrically connected to the second antenna body 13. In this embodiment, the first switch element 21 is assembled on the first antenna body 11, and the second switch element 23 is assembled on the second antenna body 13. The driving control element 30 is electrically connected to the first antenna body 11, the second antenna body 13, the first switch element 21, and the second switch element 23. The driving control element 30 is disposed on the circuit board 40. In this embodiment, the circuit board 40 may be a motherboard of the portable electronic device 100 or a circuit board connected to the motherboard of the portable electronic device 100. The driving control element 30 is electrically connected to a first feed-in point 11F of the first antenna body 11 and a second feed-in point 13F of the second antenna body 13 to receive the wireless signal and transmit the wireless signal to the portable electronic device 100 for computation, and the driving control element 30 then transmits a control signal generated according to the wireless signal. The control signal controls the first switch element 21 and the second switch element 23 to be turned on or turned off to switch a radiation pattern of the smart antenna module 1. In this embodiment, the wireless signal received by the driving control element 30 may be a Wi-Fi signal, a 4G signal, a 5G signal, or the like; however, such configuration is provided for illustrative purposes, not limitations to the instant disclosure.

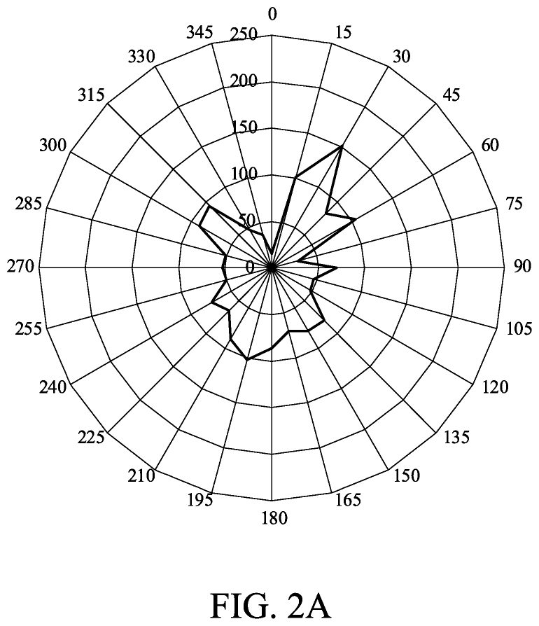

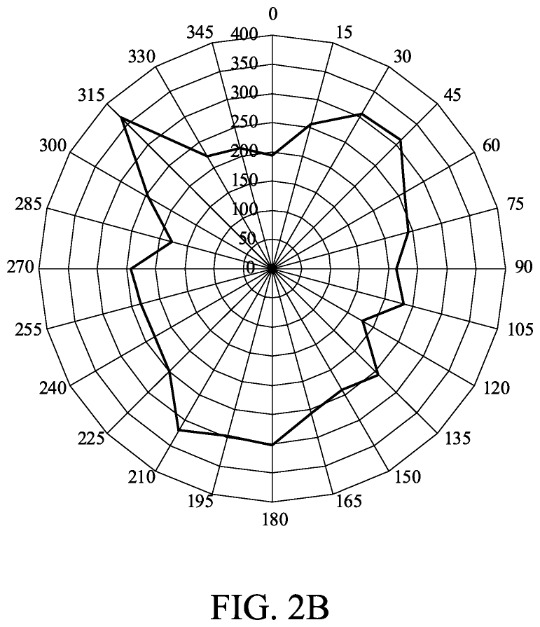

FIG. 2A and FIG. 2B illustrate reference transmitting/receiving radiation patterns of the smart antenna module according to some embodiments of the instant disclosure tested by a conductive T-put system. As shown in FIG. 2A and FIG. 2B, these figures illustrate the radiation patterns obtained by merely coupling the first antenna body 11 to the second antenna body 13 and testing the coupled components by a conductive T-put system. The resistances and the parasitic capacitances of the first switch element 21 and the second switch element 23 will change the radiation pattern. Therefore, before the configuration, the original radiation pattern can be provided as a basis, and the first switch element 21 and the second switch element 23 are configured to deploy the radiation pattern.

In this embodiment, the first switch element 21 and the second switch element 23 are diode elements. In general, the first switch element 21 and the second switch element 23 may be identical switch elements, so that a same voltage can be applied to control the switch elements to be turned on or turned off; however, such configuration is provided for illustrative purposes, not limitations to the instant disclosure. For F example, in some embodiments, the first switch element 21 and the second switch element 23 may be transistor elements.

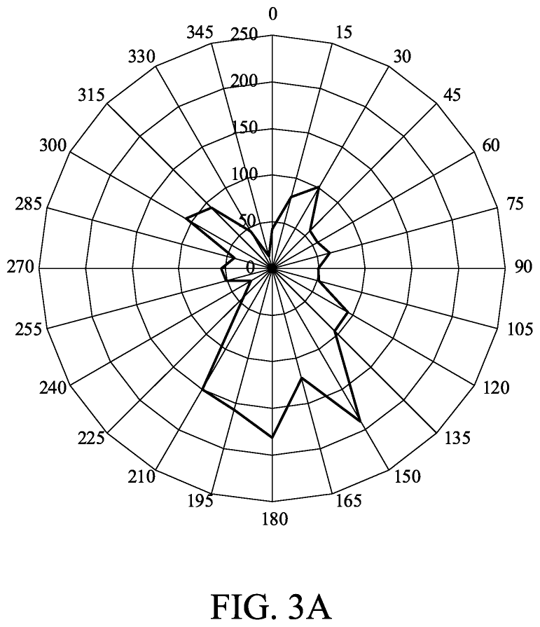

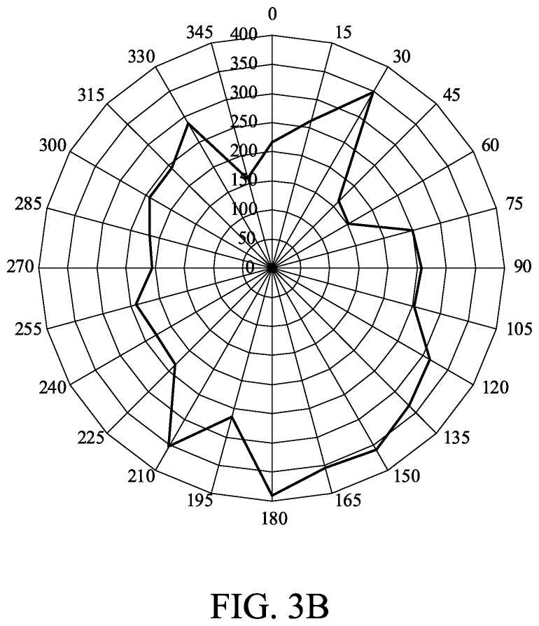

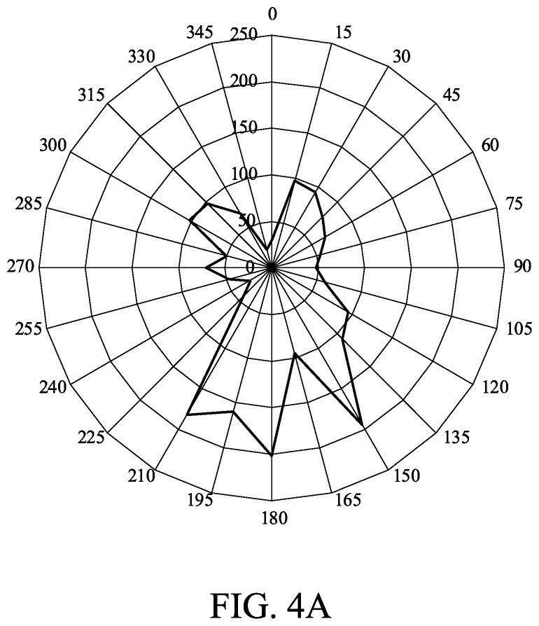

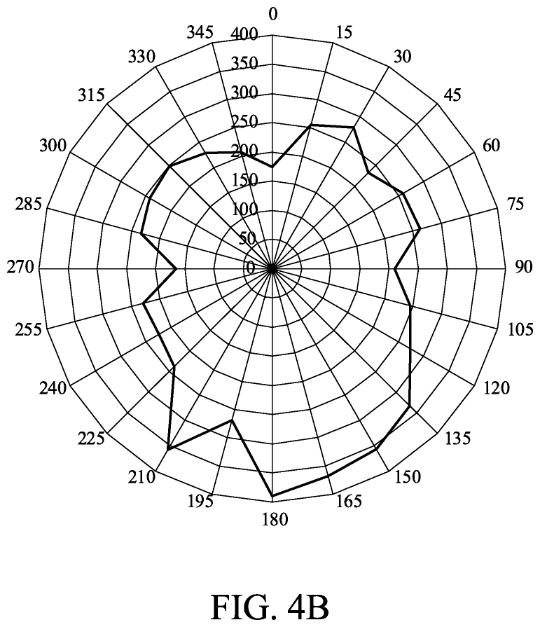

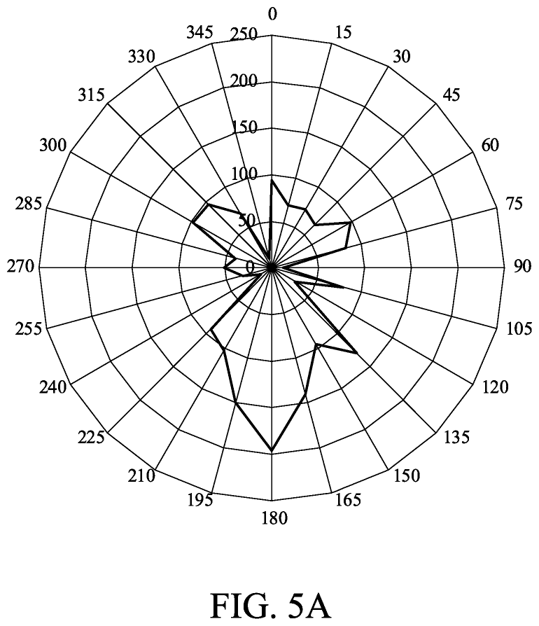

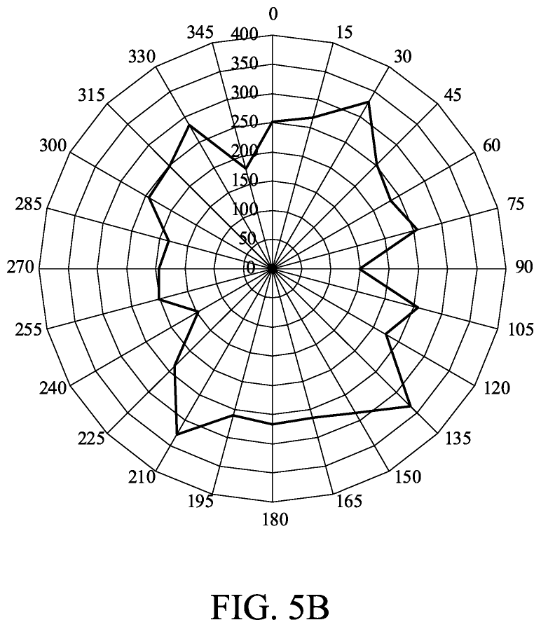

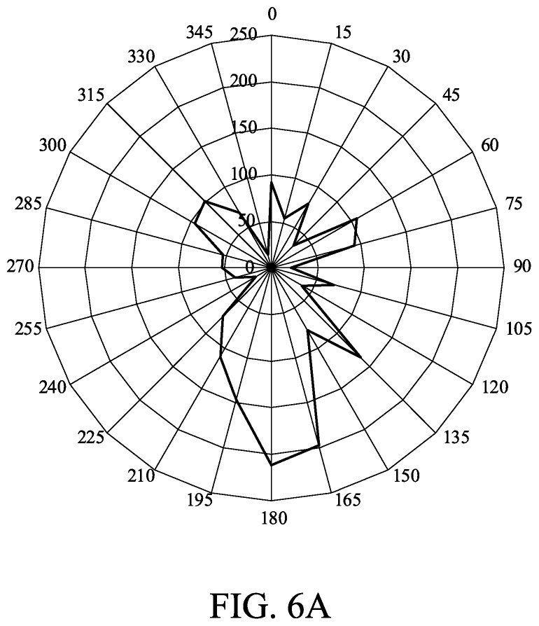

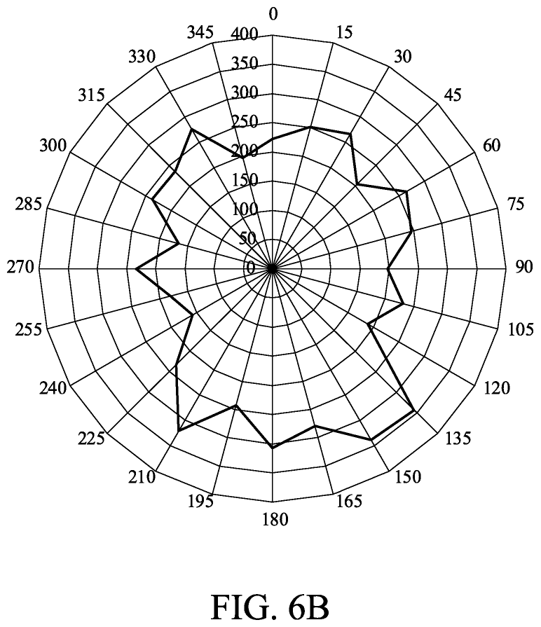

FIG. 3A and FIG. 3B illustrate transmitting/receiving radiation patterns of a first mode of the smart antenna module of some embodiments tested by the conductive T-put system. FIG. 4A and FIG. 4B illustrate transmitting/receiving radiation patterns of a second mode of the smart antenna module of some embodiments tested by the conductive T-put system. FIG. 5A and FIG. 5B illustrate transmitting/receiving radiation patterns of a third mode of the smart antenna module of some embodiments tested by the conductive T-put system. FIG. 6A and FIG. 6B illustrate transmitting/receiving radiation patterns of a fourth mode of the smart antenna module of some embodiments tested by the conductive T-put system.

FIG. 3A and FIG. 3B illustrate the operation of the first switch element 21 and the second switch element 23 under a first mode, where the first mode is an operation mode that both the first switch element 21 and the second switch element 23 are turned off (0-0). FIG. 4A and FIG. 4B illustrate the operation of the first switch element 21 and the second switch element 23 under a second mode, where the second mode is an operation mode that the first switch element 21 is turned on while the second switch element 23 is turned off (1-0). Please also refer to FIG. 2A and FIG. 2B. Under the first mode and the second mode, from 150 to 210 degrees, the radiation intensity of the transmitting and receiving end apparently increases.

FIG. 5A and FIG. 5B illustrate the operation of the first switch element 21 and the second switch element 23 under a third mode, where the third mode is an operation mode that the first switch element 21 is turned off while the second switch element 23 is turned on (0-1). Please also refer to FIG. 2A and FIG. 2B. Under the third mode, from 0 to 15 degrees and from 135 to 225 degrees, the radiation intensity of the transmitting and receiving end apparently increases.

FIG. 6A and FIG. 6B illustrate the operation of the first switch element 21 and the second switch element 23 under a fourth mode, where the fourth mode is an operation mode that both the first switch element 21 and the second switch element 23 are turned on (1-1). Please also refer to FIG. 2A and FIG. 2B. Under the fourth mode, from 0 to 15 degrees and from 135 to 225 degrees, the radiation intensity of the transmitting and receiving end apparently increases.

Accordingly, under different operation modes, the radiation intensity for certain angles can be enhanced. Therefore, the wireless signal can be received by the driving control element 30, and the wireless signal is transmitted to the portable electronic device 100 for computation to generate the control signal. Hence, the operation mode of the smart antenna module 1 can be determined, and a better communication performance can be achieved. However, such configuration is provided for illustrative purposes, not limitations to the instant disclosure. For example, in some embodiments, the driving control element 30 may comprise a computation chip, and the control signal is generated by the computation chip according to the instant wireless signal to determine the operation mode, thus allowing the reaction time for generating the control signal to be reduced.

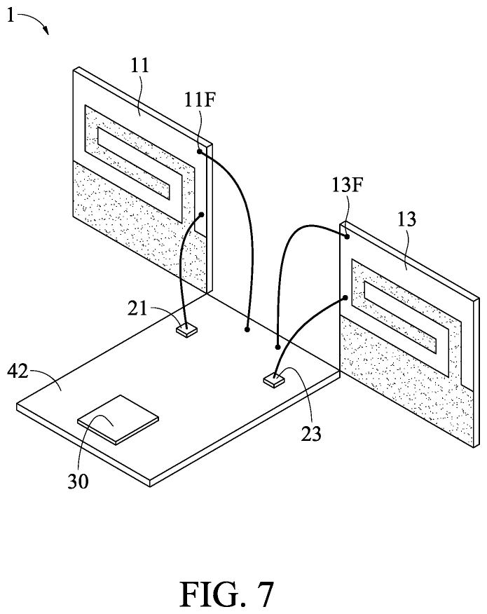

FIG. 7 illustrates a perspective view of a smart antenna module according to a second embodiment of the instant disclosure. As shown in FIG. 7, in the second embodiment, the driving control element 30, the first switch element 21, and the second switch element 23 are assembled on a flexible circuit board 42. In other words, in this embodiment, the components for controlling and switching are manufactured as a single module, and the single module is connected to the circuit board of the portable electronic device 100 through the flexible circuit board 42 to achieve data transmission and reception and to control the first antenna body 11 and the second antenna body 13. Therefore, in some embodiments, the driving control element 30, the first switch element 21, and the second switch element 23 may be manufactured as a semi-product. Moreover, in some embodiments, the first antenna body 11 and the second antenna body 23 may be manufactured independently and then electrically connected with each other, and therefore the production of the smart antenna module 1 can be accelerated.

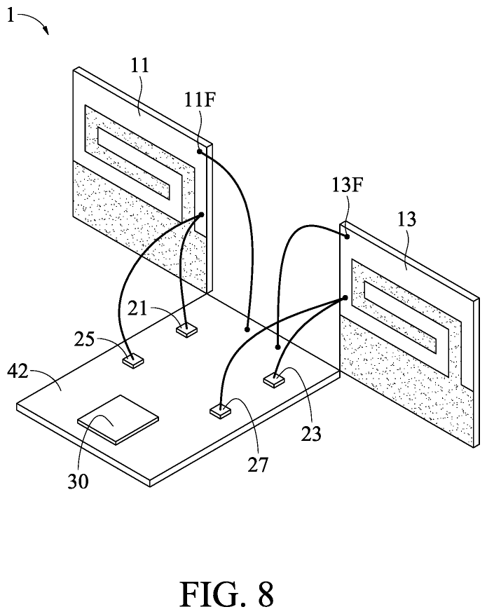

FIG. 8 illustrates a perspective view of a smart antenna module according to a third embodiment of the instant disclosure. Please also refer to FIG. 7. In the third embodiment, the smart antenna module 1 further comprises a third switch element 25 and a fourth switch element 27. The third switch element 25 is electrically connected to the first antenna body 11, and the fourth switch element 27 is electrically connected to the second antenna body 13. The driving control element 30 is electrically connected to the third switch element 25 and the fourth switch element 27. The driving control element 30 controls the first switch element 21, the second switch element 23, the third switch element 25, and the fourth switch element 27 to be turned on or turned off, so that the smart antenna module 1 can have more operation modes to correspond to different radiation patterns. It should be noted that, as compared with the first embodiment and the second embodiment, the third embodiment need more time for triggering the computation. Furthermore, it should be noted that, the antenna designer may choose proper implementations.

In FIG. 1, FIG. 7, and FIG. 8, the line connections are provided for clearly showing the electrical or signal connection between components; however, such a configuration is provided for illustrative purposes, not limitations to the instant disclosure. In practice, the configuration of the connection of circuitry may be achieved through various manners, for example, the connection between the circuit board and an electrically conductive layer, as long as the configuration can achieve the electrical and signal connection.

FIG. 9 illustrates a side view of a portable electronic device assembled with a smart antenna module according to some embodiments of the instant disclosure. FIG. 10 illustrates an enlarged schematic view of the region A shown in FIG. 9. As shown in FIG. 9 and FIG. 10, the portable electronic device 100 is a notebook computer as an illustrative example, but the instant disclosure is not limited thereto. The smart antenna module 1 is assembled on a heat dissipation housing 110 of the portable electronic device 110. The antenna of the smart antenna module 1 may be manufactured as a printed circuit or may be manufactured through applying laser engraving techniques on various materials. However, such configuration is provided for illustrative purposes, not limitations to the instant disclosure. In practices, the smart antenna module 1 may be disposed on the housing or the side surface of the portable electronic device 100.

As above, according to one or some embodiments of the instant disclosure, when the smart antenna module 1 is receiving the wireless signal, according to the blind angle of the wireless signal, the on/off switching of the first switch element 21 and the second switch element 23 can be controlled through the driving of the driving control element 30 to choose a suitable radiation pattern. Therefore, the radiation intensity for certain angles can be enhanced, thereby allowing the communication performance of the portable electronic device 100 at various fields to be further enhanced.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A smart antenna module adapted to be assembled on a portable electronic device, wherein the smart antenna module comprises:
a first antenna body;
a second antenna body electrically connected to the first antenna body, wherein the first antenna body and the second antenna body are configured to together receive or transmit a wireless signal;
a first switch element electrically connected to the first antenna body;
a second switch element electrically connected to the second antenna body; and
a driving control element electrically connected to the first antenna body, the second antenna body, the first switch element, and the second switch element, wherein the driving control element is connected to a feed-in point of the first antenna body so as to receive the wireless signal, and the driving control element is configured to transmit a control signal generated according to the wireless signal to control the first switch element and the second switch element to be turned on or turned off so as to switch a radiation pattern of the smart antenna module.

2. The smart antenna module according to claim 1, wherein the driving control element, the first switch element, and the second switch element are assembled on a flexible circuit board.

3. The smart antenna module according to claim 1, wherein the first switch element and the second switch element are diode elements or transistor elements.

4. The smart antenna module according to claim 1, wherein a frequency band of the wireless signal configured to be received by the first antenna body and the second antenna body is a Wi-Fi frequency band.

5. The smart antenna module according to claim 1, wherein a frequency band of the wireless signal configured to be received by the first antenna body and the second antenna body is a 5G frequency band.

6. The smart antenna module according to claim 1, wherein a frequency band of the wireless signal configured to be received by the first antenna body and the second antenna body is a 4G frequency band.

7. The smart antenna module according to claim 1, further comprising a third switch element and a fourth switch element, wherein the first switch element is electrically connected to the first antenna body, the fourth switch element is electrically connected to the second antenna body, the driving control element is electrically connected to the third switch element and the fourth switch element, and the driving control element further controls the third switch element and the fourth switch element to be turned on or turned off.

8. The smart antenna module according to claim 7, wherein the driving control element, the first switch element, the second switch element, the third switch element, and the fourth switch element are assembled on a flexible circuit board.

9. The smart antenna module according to claim 8, wherein the third switch element and the fourth switch element are diode elements or transistor elements.

10. A portable electronic device, wherein the portable electronic device is assembled with a smart antenna module according to claim 1.

11. A portable electronic device, wherein the portable electronic device is assembled with a smart antenna module according to claim 2.

12. A portable electronic device, wherein the portable electronic device is assembled with a smart antenna module according to claim 3.

13. A portable electronic device, wherein the portable electronic device is assembled with a smart antenna module according to claim 4.

14. A portable electronic device, wherein the portable electronic device is assembled with a smart antenna module according to claim 5.

15. A portable electronic device, wherein the portable electronic device is assembled with a smart antenna module according to claim 6.

16. A portable electronic device, wherein the portable electronic device is assembled with a smart antenna module according to claim 7.

17. A portable electronic device, wherein the portable electronic device is assembled with a smart antenna module according to claim 8.

18. A portable electronic device, wherein the portable electronic device is assembled with a smart antenna module according to claim 9.
